(19) United States
(12) Patent Application Publication
(10) Pub. No.: US 2024/0240776 A1
(43) Pub. Date: Jul. 18, 2024

(54) FIXING BASE, CONNECTION BASE AND FIXING DEVICE

(71) Applicants: SUZHOU OPPLE LIGHTING CO., LTD., Suzhou City (CN); OPPLE LIGHTING CO., LTD., Shanghai (CN)

(72) Inventor: Xianglan LI, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 18/619,349

(22) Filed: Mar. 28, 2024

Related U.S. Application Data
(63) Continuation of application No. PCT/CN2022/112943, filed on Aug. 17, 2022.

(30) Foreign Application Priority Data
Sep. 29, 2021 (CN) 202111147588.X
Sep. 29, 2021 (CN) 202122370197.6

(51) Int. Cl. F21V 21/002; F21V 17/18; F21V 21/03

(52) U.S. Cl. CPC F21V 21/002; F21V 17/18; F21V 21/03

(57) ABSTRACT

The present disclosure provides a fixing device for fixing a lamp, the fixing device includes a fixing base and a connection base, the connection base is clamped to the fixing base through rotating, a mounting component for fixing the fixing base is arranged at an outer side of the fixing base, a first connection piece is arranged in the mounting component, one end of the first connection piece is fixed with the mounting component, other end of the first connection piece is provided with a positioning hole facing an opening of the mounting component, a positioning piece facing the positioning hole is arranged in the connection base, the connection base drives the positioning piece to be clamped to or detached from the positioning hole during rotating, and a sound is generated during a clamping or detaching process of the positioning piece.

### CROSS REFERENCE TO RELATED APPLICATIONS

This application is based upon and claims the priority of PCT patent application No. PCT/CN2022/112943 filed on Aug. 17, 2022 which claims priority to the Chinese patent application No. 202122370197.6 filed on Sep. 29, 2021 and the Chinese patent application No. 202111147588.X filed on Sep. 29, 2021, the entire contents of which are hereby incorporated by reference herein for all purposes.

### TECHNICAL FIELD

The present disclosure relates to a fixing base, a connection base and a fixing device, and belongs to the technical field of lighting.

### BACKGROUND

In the installation process of the circular ceiling lamp, products are generally not provided with anti-reverse rotation pieces, which are easy to be tilted and stuck due to improper operation during assembly, resulting in product damage.

### SUMMARY

The present disclosure provides a fixing base, a connection base and a fixing device.

According to one aspect, the present disclosure provides a fixing device for fixing a lamp. The fixing device may include a fixing base and a connection base, the connection base may be clamped to the fixing base through rotating, a mounting component for fixing the fixing base may be arranged at an outer side of the fixing base, a first connection piece may be arranged in the mounting component, one end of the first connection piece may be fixed with the mounting component, other end of the first connection piece may be provided with a positioning hole facing an opening of the mounting component, a positioning piece facing the positioning hole may be arranged in the connection base, the connection base may drive the positioning piece to be clamped to or detached from the positioning hole during rotating, and a sound may be generated during a clamping or detaching process of the positioning piece.

According to another aspect, the present disclosure provides a fixing base used for cooperating with a connection base and fixing a lamp, a positioning piece may be arranged in the connection piece, a mounting component for fixing the fixing base may be arranged at an outer side of the fixing base, a first connection piece may be arranged in the mounting component, one end of the first connection piece may be fixed with the mounting component, other end of the first connection piece may be provided with a positioning hole facing an opening of the mounting component, the connection base drives the positioning piece to be clamped to or detached from the positioning hole during rotating, and a sound may be generated during a clamping or detaching process of the positioning piece.

According to a further aspect, the present disclosure provides a connection base which may be arranged in a lamp and used for cooperating with a fixing base, a positioning hole may be arranged in the fixing base, a positioning piece for cooperating with the positioning hole may be arranged in the connection base, the connection base may drive the positioning piece to be clamped to or detached from the positioning hole during rotating, and a sound may be generated during a clamping or detaching process of the positioning piece.

It is to be understood that both the foregoing general description and the following detailed description are exemplary and explanatory only and are not restrictive of the present disclosure.

### BRIEF DESCRIPTION OF DRAWINGS

FIG. 1 is a schematic structural diagram of a lamp according to an example of the present disclosure;

FIG. 2 is an exploded structural view of a fixing device according to an example of the present disclosure;

FIG. 3 is an exploded structural view of a fixing base in a fixing device according to an example of the present disclosure;

FIG. 4 is an exploded structural view of a connection base in a fixing device according to an example of the present disclosure;

FIG. 5 is an exploded structural view, from another viewing angle, of a connection base in a fixing device according to an example of the present disclosure; and

FIG. 6 is a schematic structural diagram of cooperation between a positioning piece and a positioning hole in a fixing device according to an example of the present disclosure.

### DETAILED DESCRIPTION

In order to make the purposes, technical solutions and advantages of the present disclosure more clear, the present disclosure will be described in detail below in conjunction with the accompanying drawings and examples.

Here, it should be noted that in order to avoid obscuring the present disclosure with unnecessary details, only the structure and/or processing steps closely related to the solutions of the present disclosure are shown in the accompanying drawings, while other details that are not closely related to the present disclosure are omitted.

In addition, it should be noted that the terms “comprising”, “including” or any other variations thereof are intended to cover non-exclusive inclusion, so that a process, method, article or apparatus including a series of elements includes not only these elements, but also other elements not explicitly listed, or elements inherent to such process, method, article or apparatus.

Sometimes, in the rotating assembly process of circular ceiling lamps, operators cannot know whether they are accurately assembled in place; if they are not assembled in place, the products may fall off, while if they are over-assembled, the products may be damaged.

In view of this, it is necessary to propose improvements to the fixing base, connection base and fixing device, so as to solve the above problems.

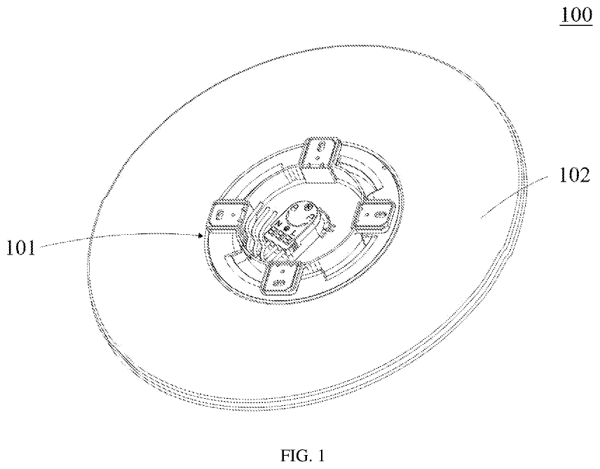

As shown in FIGS. 1-6, the present disclosure discloses a lamp 100, the lamp 100 includes a fixing device 101 and a lamp body 102 that are convenient for installation and disassembly, one end of the fixing device 101 is configured to be mounted on a mounting surface, and the other end of the fixing device 101 is configured to be connected to the lamp body 102. For the sake of clarity, the specific structure of the fixing device 101 will be described in detail in the following description.

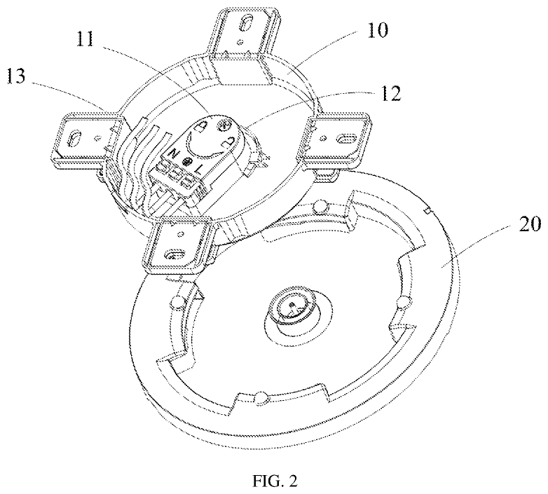

As shown in FIGS. 2-4, the fixing device 101 includes a fixing base 10 and a connection base 20, the fixing base 10 is provided with a first lead terminal 11 for connecting commercial power and a plug hole (not shown), the connection base 20 is provided with a second lead terminal 21 for connecting the lamp body 102, the first lead terminal 11 is arranged at one side of the plug hole, and the connection base 20 is arranged at the other side of the plug hole. After the connection base 20 is clamped to the fixing base 10 through rotating, the second lead terminal 21 passes through the plug hole to be electrically connected with the first lead terminal 11, so as to supply power to the lamp 100. Further, a position stopper 12 is provided at a side of the plug hole close to the first lead terminal 11, and the position stopper 12 is used to prevent the first lead terminal 11 from rotating around the plug hole to avoid wire twisting.

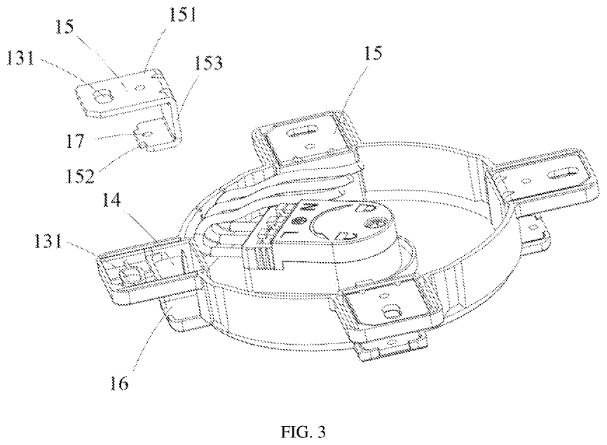

As shown in FIG. 3, the fixing base 10 is used to be fixed on a mounting surface, such as a wall or a ceiling, etc., a mounting component 13 is arranged at the outer side of the fixing base 10, the mounting component 13 is provided with a mounting hole 131 and a mounting piece (not shown), and the mounting piece passes through the mounting hole 131 to fix the fixing base 10 on the mounting surface. In other examples of the present disclosure, the cross-section of the mounting hole 131 may be strip-shaped, and the mounting piece can move laterally along the mounting hole 131 to facilitate timely adjustment of the mounting position. Further, the extension directions of the strip-shaped mounting holes 131 on different mounting components 13 may be different, and preferably, are perpendicular to each other. It can be understood that the structural stability of the fixing base 10 can be enhanced by arranging multiple mounting components 13. In the present disclosure, it is preferable to arrange four mounting components 13, and the four mounting components 13 are evenly distributed on the circumferential outer side of the fixing base 10.

The mounting component 13 is provided with a through groove 14 penetrating through the mounting component, and a first connection piece 15 is arranged in the through groove 14. A first limiting piece 16 configured to support the first connection piece 15 is further arranged at the outer side of the fixing base 10, the mounting component 13 and the first limiting piece 16 are coaxially arranged along the circumferential outer wall of the fixing base 10, and two ends of the first connection piece 15 are fixedly connected to the mounting component 13 and the first limiting piece 16, respectively. Preferably, there are four first connection pieces 15 and four first limiting pieces 16 corresponding to the mounting components 13.

Specifically, the first connection piece 15 includes a first end 151, a second end 152, and a third end 153 configured to connect the first end 151 and the second end 152; the size of the first end 151 is greater than the size of the opening of the through groove 14, both the size of the second end 152 and the size of the third end 153 are less than the size of the opening of the through groove 14, and the second end 152 of the first connection piece 15 extends downward from the through groove 14, so that the second end 152 is attached to the first limiting piece 16 and fastened to the first limiting piece 16 by a fastening piece. Similarly, the first end 151 and the third end 153 are respectively attached to the mounting component 13 and the outer wall the fixing base 10, and are fastened by fastening pieces, so as to enhance the structural stability of the fixing base 10. The specific structure, in which the second end 152 is attached to the first limiting piece 16, can be set as needed, including but not limited to setting a slot or hole structure matching with the second end 152 on the first limiting piece 16. Preferably, the first connection piece 15 includes, but is not limited to, hardware, as long as it has strong structural strength and is not easily to be deformed. It can be understood that the first end 151 is provided with a slot or hole corresponding to the mounting hole 131.

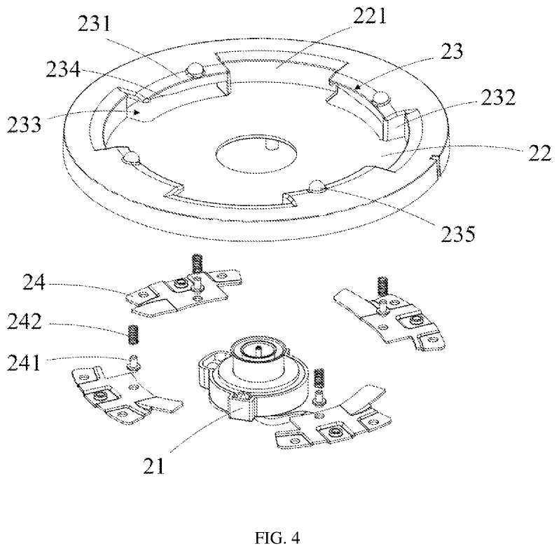

As shown in FIG. 4, the connection base 20 is configured to be connected to the lamp body 102. Of course, it can be understood that in other examples of the present disclosure, the connection base 20 may be integral with the lamp body 102, and the lamp body 102 may be directly connected to the fixing base 10 as illustrated, which is not limited to this case here. A first accommodation cavity 22 configured to accommodate the fixing base 10 is arranged in the connection base 20. It can be understood that the main body of the fixing base 10 is accommodated in the first accommodation cavity 22, and the mounting component 13 is arranged at the outer side of the first accommodation cavity 22. The connection base 20 is partially recessed to form the first accommodation cavity 22, the first accommodation cavity 22 includes an annular wall 221, a second limiting piece 23 is arranged at the inner side of the annular wall 221, and the second limiting piece 23 is configured to cooperate with the first limiting piece 16 to limit each other. Specifically, the second limiting piece 23 includes a bearing portion 231 abutting against the first limiting piece 16 and a stopping portion 232 for preventing excessive rotation of the first limiting piece, and the bearing portion 231 and the stopping portion 232 are connected and enclosed to form a second accommodation cavity 233 configured to accommodate the first limiting piece 16. Preferably, there are four second limiting pieces 23 corresponding to the first limiting pieces 16.

Specifically, the second accommodation cavity 233 is provided with an opening along the circumferential direction of the annular wall 221, the opening and the stopping portion 232 are respectively located at two sides of the bearing portion 231 along the circumferential direction of the annular wall 221. When the connection base 20 is matched with the fixing base 10, the first limiting piece 16 can be clamped between adjacent second limiting pieces 23, and the connection base 20 rotates to drive the first limiting piece 16 to rotate into the second accommodation cavity 233 of the second limiting piece 23, so as to realize the clamping fit with the fixing base 10, thus completing the installation of the lamp 100. If the lamp 100 needs to be disassembled, it is only needed to reversely rotate the connection base 20.

In the example of the present disclosure, the bearing portion 231 is provided with a guide portion 234 at the opening, the guide portion 234 is plate-shaped, and the guide portion 234 enable the second accommodation cavity 233 to has a tendency to gradually shrink inward from the opening, that is, the cross-sectional area of the second accommodation cavity 233 gradually decreases from the opening to the stopping portion 232, so as to increase the size of the opening and facilitate the first limiting piece to move along the guide portion 234 into the second accommodation cavity 233.

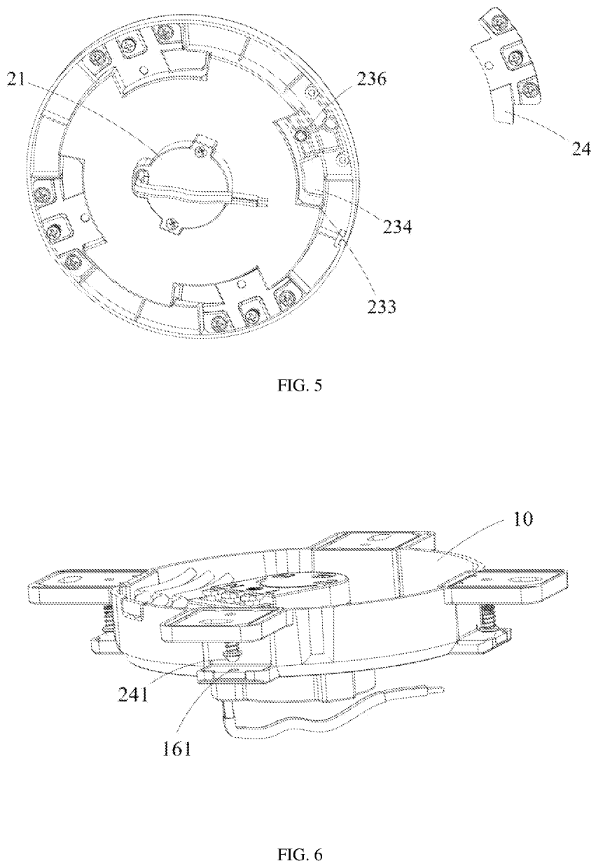

As shown in FIG. 5, in other examples of the present disclosure, a second connection piece 24 attached to the bearing portion 231 is arranged in the second accommodation cavity 233, a part of the second connection piece 24 is fixedly connected to the bearing portion 231, another part of the second connection piece 24 is fixedly connected to the connection base 20, and the second connection piece 24 is used for strengthening the structural strength between the second accommodation cavity 233 and the connection base 20. Preferably, the second connection piece 24 includes, but is not limited to, hardware, as long as it has strong structural strength and is not easily to be deformed.

In other examples of the present disclosure, the bearing portion 231 is not horizontally arranged, that is, the bearing portion 231 is higher at the opening and lower at the stopping portion 232, so that the first limiting piece 16 has a tendency to move towards the stopping portion 232 in the second accommodation cavity 233 under the action of gravity, so as to prevent accidental detachment of the lamp body 102.

As shown in FIG. 4 and FIG. 6, as an example of the present disclosure, the connection base 20 can generate an indication sound of being assembled in place during the assembly process with fixing base 10. Specifically, the first limiting piece 16 is provided with a positioning hole 17 facing the opening of the mounting component 13. In other examples, in the case where the first connection piece 15 is closer to the mounting component 13, the positioning hole 17 may be arranged at the second end 152 of the first connection piece 15, which is not limited to this here. A positioning piece 241 facing the positioning hole 17 is arranged in the second accommodation cavity 233. When the first limiting piece 16 is clamped into the second accommodation cavity 233, the first limiting piece 16 presses the positioning piece 241 thereby elastic deformation is generated, and with the continuous movement of the first limiting piece 16, the positioning piece 241 is clamped into the positioning hole 17, and a sound is generated due to vibration in the process of elasticity reset to indicate the assembly in place. On the contrary, in the process of disassembly of the fixing device 101 and a lamp body 102, the first limiting piece 16 reversely moves, and elastic deformation is generated on the positioning piece 241 accompanied by a sound to indicate the completion of detachment.

In the example of the present disclosure, the bearing portion 231 is provided with a protrusion portion 235 protruding in a direction away from the second accommodation cavity 233. Because the opening of the second accommodation cavity 233 is relatively large, the connection piece is prone to be oblique during the assembly, and the protrusion portion 235 is configured to abut against the mounting component 13 when the connection base 20 is obliquely mounted relative to the fixing base 10, so as to avoid wrong installation.

Further, a third accommodation cavity 236 communicating with the second accommodation cavity 233 is arranged in the protrusion portion 235, the positioning piece 241 is partially accommodated in the third accommodation cavity 236, a through hole is formed in the second connection piece 24 corresponding to the third accommodation cavity 236, and the positioning piece 241 extends into the second accommodation cavity 233 from the third accommodation cavity 236 by passing through the bearing portion 231 and the second connection piece 24. An elastic piece 242 for resetting the positioning piece 241 is further arranged in the third accommodation cavity 236. The elastic piece 242 may be a spring, and the elastic piece 242 is sleeved on the positioning piece 241 and accommodated in the third accommodation cavity 236. When the positioning piece 241 is pressed by the first limiting piece 16, the elastic piece 242 receives pressure and contracts with the positioning piece 241 into the third accommodation cavity 236. When the lamp is assembled in place, the positioning piece 241 is reset under the clastic force of the elastic piece 242 and clamped into the positioning hole 17.

In summary, in the present disclosure, the protrusion portion 235 is provided in the lamp 100, so that the connection base 20 and the fixing base 10 are prevented from being obliquely clamped in the assembly process of the lamp, and an indicating sound is generated when the lamp is assembled in place.

The present disclosure provides a fixing base, a connection base and a fixing device, which can indicate whether a lamp is assembled in place.

The present disclosure provides a fixing device for fixing a lamp, the fixing device includes a fixing base and a connection base, the connection base is clamped to the fixing base through rotating, a mounting component for fixing the fixing base is arranged at an outer side of the fixing base, a first connection piece is arranged in the mounting component, one end of the first connection piece is fixed with the mounting component, other end of the first connection piece is provided with a positioning hole facing an opening of the mounting component, a positioning piece facing the positioning hole is arranged in the connection base, the connection base drives the positioning piece to be clamped to or detached from the positioning hole during rotating, and a sound is generated during a clamping or detaching process of the positioning piece.

As a further improvement of the present disclosure, a first limiting piece for supporting the first connection piece is further arranged at the outer side of the fixing base, and two ends of the first connection piece are fixedly connected to the mounting component and the first limiting piece, respectively.

As a further improvement of the present disclosure, a first accommodation cavity for accommodating the fixing base is arranged in the connection base, the first accommodation cavity comprises an annular wall provided with a second limiting piece, the second limiting piece is configured to cooperate with the first limiting piece to limit each other, the second limiting piece comprises a bearing portion abutting against the first limiting piece and a stopping portion for preventing excessive rotation of the first limiting piece, and the bearing portion and the stopping portion are enclosed to form a second accommodation cavity configured to accommodate the first limiting piece.

As a further improvement of the present disclosure, the bearing portion is not horizontally arranged, so that the first limiting piece has a tendency to move towards the stopping portion in the accommodation cavity.

As a further improvement of the present disclosure, the second accommodation cavity is provided with an opening along a circumferential direction of the annular wall, the opening and the stopping portion are respectively located at two sides of the bearing portion along the circumferential direction of the annular wall, the bearing portion is provided with a guide portion at the opening, and the guide portion enables the second accommodation cavity to has a tendency to gradually shrink inward from the opening.

As a further improvement of the present disclosure, the bearing portion is provided with a protrusion portion away from the second accommodation cavity, and the protrusion portion is configured to abut against the mounting component when the connection base is obliquely mounted relative to the fixing base.

As a further improvement of the present disclosure, a third accommodation cavity communicated with the second accommodation cavity is arranged in the protrusion portion, the positioning piece is partially accommodated in the third accommodation cavity, and an elastic piece configured to reset the positioning piece is further arranged in the third accommodation cavity.

As a further improvement of the present disclosure, a second connection piece attached to the bearing portion is arranged in the second accommodation cavity, a part of the second connection piece is fixedly connected to the bearing portion, another part of the second connection piece is fixedly connected to the connection base, and the positioning piece extends into the second accommodation cavity from the third accommodation cavity by passing through the bearing portion and the second connection piece.

As a further improvement of the present disclosure, the fixing base is provided with a first lead terminal for connecting commercial power, the connection base is provided with a second lead terminal for connecting an electrical equipment, and after the connection base is clamped to the fixing base through rotating, the first lead terminal is electrically connected with the second lead terminal.

In order to achieve the above purpose, the present disclosure further provides a fixing base used for cooperating with a connection base and fixing a lamp, a positioning piece is arranged in the connection piece, a mounting component for fixing the fixing base is arranged at an outer side of the fixing base, a first connection piece is arranged in the mounting component, one end of the first connection piece is fixed with the mounting component, other end of the first connection piece is provided with a positioning hole facing an opening of the mounting component, the connection base drives the positioning piece to be clamped to or detached from the positioning hole during rotating, and a sound is generated during a clamping or detaching process of the positioning piece.

As a further improvement of the present disclosure, a first limiting piece configured to support the first connection piece is further arranged at the outer side of the fixing base, and two ends of the first connection piece are fixedly connected to the mounting component and the first limiting piece, respectively.

In order to achieve the above purpose, the present disclosure further provides a connection base which is arranged in a lamp and used for cooperating with a fixing base, a positioning hole is arranged in the fixing base, a positioning piece for cooperating with the positioning hole is arranged in the connection base, the connection base drives the positioning piece to be clamped to or detached from the positioning hole during rotating, and a sound is generated during a clamping or detaching process of the positioning piece.

As a further improvement of the present disclosure, a first accommodation cavity configured to accommodate the fixing base is arranged in the connection base, the first accommodation cavity comprises an annular wall provided with a second limiting piece, and the second limiting piece is configured to cooperate with the first limiting piece of the fixing base to limit each other.

As a further improvement of the present disclosure, the second limiting piece comprises a bearing portion abutting against the first limiting piece and a stopping portion for preventing excessive rotation of the first limiting piece, the bearing portion and the stopping portion are enclosed to form a second accommodation cavity configured to accommodate the first limiting piece, and the positioning piece is arranged on the bearing portion in the second accommodation cavity.

The present disclosure has the beneficial effects that: in the present disclosure, by arranging the protrusion portion in the lamp, the connection base and the fixing base are prevented from being obliquely clamped in the assembly process, and an indicating sound is generated when the lamp is assembled in place.

The above examples are only used to illustrate the technical solutions of the present disclosure, but not restrictive. Although the present disclosure has been described in detail with reference to the examples, it should be understood by those skilled in the art that the technical solutions of the present disclosure can be modified or replaced by equivalents without departing from the spirit and scope of the technical solutions of the present disclosure.

1. A fixing device for fixing a lamp, comprising:
a fixing base and a connection base, wherein:
the connection base is clamped to the fixing base through rotating, a mounting component for fixing the fixing base is arranged at an outer side of the fixing base, a first connection piece is arranged in the mounting component, one end of the first connection piece is fixed with the mounting component, other end of the first connection piece is provided with a positioning hole facing an opening of the mounting component, a positioning piece facing the positioning hole is arranged in the connection base, the connection base drives the positioning piece to be clamped to or detached from the positioning hole during rotating, and a sound is generated during a clamping or detaching process of the positioning piece.

2. The fixing device according to claim 1, wherein a first limiting piece for supporting the first connection piece is further arranged at the outer side of the fixing base, and two ends of the first connection piece are fixedly connected to the mounting component and the first limiting piece.

3. The fixing device according to claim 2, wherein:
a first accommodation cavity for accommodating the fixing base is arranged in the connection base, the first accommodation cavity comprises an annular wall provided with a second limiting piece, the second limiting piece is configured to cooperate with the first limiting piece to limit each other, the second limiting piece comprises a bearing portion abutting against the first limiting piece and a stopping portion for preventing excessive rotation of the first limiting piece, and the bearing portion and the stopping portion are enclosed to form a second accommodation cavity configured to accommodate the first limiting piece.

4. The fixing device according to claim 3, wherein the bearing portion is not horizontally arranged, so that the first limiting piece has a tendency to move towards the stopping portion in the accommodation cavity.

5. The fixing device according to claim 3, wherein:
the second accommodation cavity is provided with an opening along a circumferential direction of the annular wall, the opening and the stopping portion are respectively located at two sides of the bearing portion along the circumferential direction of the annular wall, the bearing portion is provided with a guide portion at the opening, and the guide portion enables the second accommodation cavity to has a tendency to gradually shrink inward from the opening.

6. The fixing device according to claim 3, wherein the bearing portion is provided with a protrusion portion away from the second accommodation cavity, and the protrusion portion is configured to abut against the mounting component when the connection base is obliquely mounted relative to the fixing base.

7. The fixing device according to claim 6, wherein a third accommodation cavity communicated with the second accommodation cavity is arranged in the protrusion portion, the positioning piece is partially accommodated in the third accommodation cavity, and an elastic piece configured to reset the positioning piece is further arranged in the third accommodation cavity.

8. The fixing device according to claim 7, wherein a second connection piece attached to the bearing portion is arranged in the second accommodation cavity, a part of the second connection piece is fixedly connected to the bearing portion, another part of the second connection piece is fixedly connected to the connection base, and the positioning piece extends into the second accommodation cavity from the third accommodation cavity by passing through the bearing portion and the second connection piece.

9. The fixing device according to claim 1, wherein the fixing base is provided with a first lead terminal for connecting commercial power, the connection base is provided with a second lead terminal for connecting an electrical equipment, and after the connection base is clamped to the fixing base through rotating, the first lead terminal is electrically connected with the second lead terminal.

10. A fixing base, used for cooperating with a connection base and fixing a lamp, wherein:
a positioning piece is arranged in the connection piece, a mounting component for fixing the fixing base is arranged at an outer side of the fixing base, a first connection piece is arranged in the mounting component, one end of the first connection piece is fixed with the mounting component, other end of the first connection piece is provided with a positioning hole facing an opening of the mounting component, the connection base drives the positioning piece to be clamped to or detached from the positioning hole during rotating, and a sound is generated during a clamping or detaching process of the positioning piece.

11. The fixing base according to claim 10, wherein a first limiting piece configured to support the first connection piece is further arranged at the outer side of the fixing base, and two ends of the first connection piece are fixedly connected to the mounting component and the first limiting piece.

12. A connection base, arranged in a lamp and used for cooperating with a fixing base, wherein:
a positioning hole is arranged in the fixing base, a positioning piece for cooperating with the positioning hole is arranged in the connection base, the connection base drives the positioning piece to be clamped to or detached from the positioning hole during rotating, and a sound is generated during a clamping or detaching process of the positioning piece.

13. The connection base according to claim 12, wherein a first accommodation cavity configured to accommodate the fixing base is arranged in the connection base, the first accommodation cavity comprises an annular wall provided with a second limiting piece, and the second limiting piece is configured to cooperate with the first limiting piece of the fixing base to limit each other.

14. The connection base according to claim 13, wherein the second limiting piece comprises a bearing portion abutting against the first limiting piece and a stopping portion for preventing excessive rotation of the first limiting piece, the bearing portion and the stopping portion are enclosed to form a second accommodation cavity configured to accommodate the first limiting piece, and the positioning piece is arranged on the bearing portion in the second accommodation cavity.
